(19) United States
(12) Patent Application Publication
(10) Pub. No.: US 2024/0184242 A1
(43) Pub. Date: Jun. 6, 2024

(54) Data-efficient Photorealistic 3D Holography

(71) Applicant: Massachusetts Institute of Technology, Cambridge, MA (US)

(72) Inventors: Wojciech Matusik, Cambridge, MA (US); Liang Shi, Cambridge, MA (US)

(21) Appl. No.: 18/284,920

(22) PCT Filed: Mar. 25, 2022
(86) PCT No.: PCT/US2022/021853

§ 371 Date: Sep. 29, 2023

Related U.S. Application Data
(63) Continuation-in-part of application No. PCT/US2021/028449, filed on Apr. 21, 2021.
(60) Provisional application No. 63/257,823, filed on Oct. 20, 2021.
(60) Provisional application No. 63/167,441, filed on Mar. 29, 2021.
(60) Provisional application No. 63/013,308, filed on Apr. 21, 2020.
(60) Provisional application No. 63/167,441, filed on Mar. 29, 2021.

(51) Int. Cl. G03H 1/08; G03H 1/04; G03H 1/22; G03H 1/26

(52) U.S. Cl. CPC G03H 1/0841; G03H 1/0406; G03H 1/0866; G03H 2001/085; G03H 2001/2271; G03H 2001/2605

(57) ABSTRACT

A number of techniques provide a data efficient and/or computation efficient computer-generated holography, examples of which may be implemented on low-power devices such as smartphones and virtual-reality/augmented-reality devices and provide high fidelity holographic images. The techniques include used of layered depth image representations and end-to-end training of neural network generation of double-phase hologram encoding.

### CROSS-REFERENCES TO RELATED APPLICATIONS

This application claims the benefit of: U.S. Provisional Application No. 63/167,441, filed Mar. 29, 2021 and titled “Data-Efficient Photorealistic 3D Holography using Layered Depth Images and Deep Double Phase Encoding”; PCT Application No. PCT/US21/28449, filed Apr. 21, 2021, published as WO/2021/216747 on Oct. 28, 2021, and titled “Real-Time Photorealistic 3D Holography with Deep Neural Networks”; and U.S. Provisional Application No. 63/257,823, filed Oct. 20, 2021 and titled “Data-Efficient Photorealistic 3D Holography,” which are incorporated herein by reference.

For United States purposes, this application is a Continuation-in-Part (CIP) of PCT Application No. PCT/US21/28449, filed Apr. 21, 2021, which claims the benefit of U.S. Provisional Applications 63/013,308, filed Apr. 21, 2020, and 63/167,441, filed Mar. 29, 2021, which are each incorporated herein by reference.

### BACKGROUND OF THE INVENTION

This invention relates to data-efficient photorealistic 3D holography, and in particular use of Layered Depth Images and Deep Double Phase Encoding.

### SUMMARY OF THE INVENTION

A number of techniques, whether used alone or in combination, provide data efficient and/or computation efficient computer-generated holography, examples of which may be implemented on low-power devices such as smartphones and virtual-reality/augmented-reality devices and provide high fidelity holographic images. These techniques include:
Use of a layered depth image (an “LDI representation”), for example, generated using ray tracing to record a relatively small number of layered RGB+depth images (“RBGD”), from which a digital holograph is computed.
Direct computation of a double-phase representation of a hologram, for example, by training a CNN (or a collection of separate interconnected CNNs) to generate a complex hologram that best yields a double-phase representation (e.g., by matching a focal stack rather than directly aiming to reproduce a complex hologram).
Integration of vision correction (e.g., astigmatism) and/or lens aberration correction in neural network based hologram generation.

In a first aspect, in general, a first method for generating a digital hologram includes accepting a layered representation (an “LDI” representation) of a three-dimension image and forming the digital hologram from the LDI representation. The LDI representation includes, for each location of a plurality of locations (e.g., x-y pixels) of the hologram, two or more depth values (e.g., z values) each representing spatial coordinates of a point along a line (e.g., a ray along the z-axis) at an intersection of the line and a surface of an object in the three-dimensional image. In at least some examples, the layered representation comprises corresponding two or more RGB+depth (“RGBD”) images, where the depth values are not necessarily quantized at a voxel-based resolution of the three-dimensional image. In some examples, the LDI representation is precomputed, for example, using a ray-casting procedure resulting in a fixed size representation (e.g., a fixed number of RBGD images per video frame) that is stored and retrieved as the images are rendered in holographic form, while in other examples, the LDI representations are determined “on the fly.” for example, based on retrieving a stored surface model representation of each three-dimensional image.

In a second aspect, in general, a second method for generating a digital hologram includes accepting a layered representation (an “LDI” representation) of a three-dimension image and using a neural network to generate the digital hologram from the LDI representation. The method includes inputting the layered representation of one RBGD layer and preferably at least two layers (e.g., all layers of the layered representation) into a neural network (e.g., a convolutional neural network, CNN) whose output is used to generate the digital hologram. In some examples, the output of the CNN represents a complex hologram (e.g., an array of representations of magnitude and phase), and the complex hologram is further processed to form a double-phase representation (e.g., an array of pairs of phases, which together represent magnitude and phase) of the hologram.

The method for generating the digital hologram can include one or more of the following features.

The layered representation of the three-dimensional image (or sequential images/frames of a video) is precomputed and stored, and retrieved during generation of the hologram.

The layered representation of the three-dimensional image is computed during the generation of the hologram (e.g., frame by frame for a video).

The layered representation is computed based on a user's direction of view, for example, determined using an eye tracker.

In a third aspect, in general, a method for training (e.g., determining values of configurable parameters/weights of) the neural network used in the second method for generating a digital hologram uses training data that for each training item associates an LDI representation of a three-dimensional image as input and a function of a double-phase hologram representation as output. In some examples, this training method permits end-to-end training of the neural network to match the function of the double-phase representation and a function of a reference hologram corresponding to the LDI representation.

The method for training the neural network can include one or more of the following features.

The reference hologram is generated using the first method for generating a digital hologram from an LDI representation.

The function of the double-phase representation and the function of the reference hologram each comprises a focal stack of images.

The neural network is trained to optimize a match of (e.g., to minimize a loss function between) a focal stack (e.g., a set of images determined at different focal lengths derived from a hologram) derived from the double-phase encoding and a target focal stack corresponding to the input LDI representation. For example, the neural network is configured to generate a complex hologram that is passed through a complex hologram to double-phase encoder. Training then optimizes the neural network to best generate the complex hologram suitable for processing through the double-phase encoder.

The neural network includes two parts, for example, two separate CNNs. Training of the first part is based on a matching of a target hologram with an output of the first part of the neural network (e.g., a complex hologram and/or a midpoint hologram), for example, based on the matching of a target focal stack with a focal stack derived from the output of the first part of the neural network.

After the first part is trained, the second part (e.g., a second CNN) is trained to accept an output (e.g., a complex hologram) of the first part (or a transformation of that output) as its input and to generate a pre-processed complex hologram that is passed through a complex hologram to a double-phase encoder. The training of the second part is based, for example, on the matching of a target focal stack with a focal stack derived from the double-phase encoding. In some examples, the second part essentially pre-processes a complex hologram before feeding the resulting pre-processed hologram to the complex hologram to the double-phase encoder to better eliminate encoding artifacts.

In another aspect, in general, a method for generating a digital hologram using a neural network integrates at least one of vision correction (e.g., astigmatism) and lens aberration correction into the neural network. In these methods, the target hologram (and thereby the functions of the target hologram) incorporates the optical effects that correct the vision or lens effects. The neural network then learns a transformation that essentially integrates the correction thereby avoiding a need for further correction prior to presentation of a holographic image to the user.

In yet another aspect, in general, a holographic imaging system includes a neural network that accepts a layered representation of a three-dimension image (or video frame sequence) as input and uses the neural network to generate a double-phase hologram that configures a spatial light modulator (SLM). The system includes a light source for passing light via the SLM to yield a holographic image, for example, for presentation to a user. Some examples of the system include a ray tracer for generating the layered representations from three-dimensional (e.g., surface) representations of objects in the image.

Other features and advantages of the invention are apparent from the following description, and from the claims.

### DESCRIPTION OF DRAWINGS

FIG. 1 is a block diagram of a holographic display system.

FIG. 2 is a diagram illustrating a layered depth image decomposition process used in the system of FIG. 1.

FIG. 3 is an illustration of a layered depth image decomposition of a sample three-dimensional scene.

FIG. 4 is a block diagram of a process for processing a layered depth image decomposition to produce a phase-only hologram.

FIG. 5 is a block diagram of a process for processing a layered depth image decomposition to produce training data.

FIG. 6 is a block diagram of a first training stage.

FIG. 7 is a block diagram of a second training stage.

### DETAILED DESCRIPTION

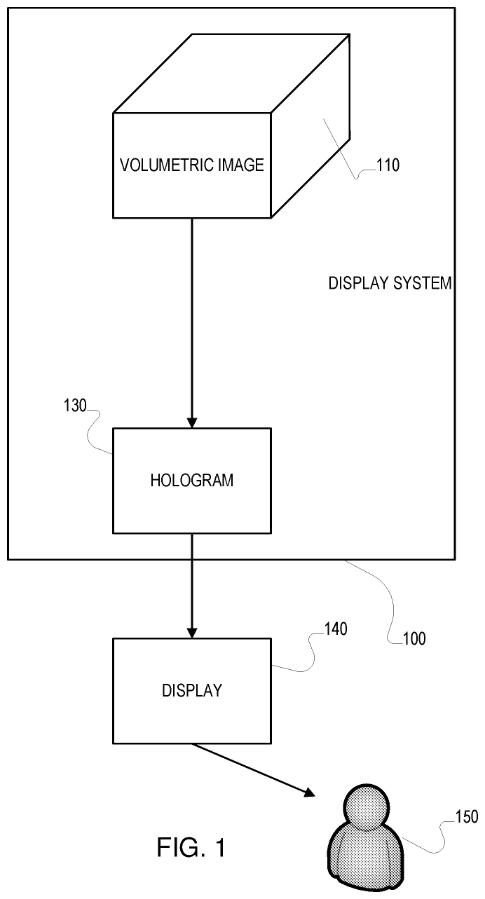

Referring to FIG. 1, a display system 100 processes a volumetric image 110 for presentation via a display 140 to a viewer 150 in such a way that the viewer perceives the three-dimensional character of the volumetric image 110 making use of holographic techniques. For example, the volumetric image 110 defines points or surfaces in three dimensions according to their color, represented by intensity in each of multiple color channels (e.g., Red-Green-Blue, RGB). Digital processing of the volumetric image 110 in the display system 100 yields a digital hologram 130, which is used to configure the display 140. The display 140 is a physical device in which the phase of light (and in some examples amplitude) emitted from or transmitted through the device is controllable as a function of position, for example, with each discrete pixel location in the display having an electronically and/or digitally controllable phase selectable from a continuous or discrete set of values for each of one or more color channels.

In some examples, the hologram 130 may represent an amplitude and a phase (e.g., a gain and a phase delay) at each location in the image for each color channel. Such a hologram may be referred to and computationally represented as a “complex” intensity, recognizing that representation of phase and magnitude using complex numbers is a mathematical convenience rather than necessarily corresponding to a physical phenomenon. In some examples, hologram 130 may represent a phase-only hologram in which only the phase (and not the amplitude) is represented for each location in the image. The display 140 may be viewed via a viewer's natural optical system, that is, their eyes, of through a physical or simulated lens system to yield a two-dimensional image as one would produce, for example, using a conventional camera. As described below, in some embodiments, the formation of the complex image takes into account characteristics of the optical system used to view the image, for example, to compensate for certain non-ideal properties of such an optical system. In one such embodiment, the optical system is a user's natural vision system and the non-ideal properties are near- or far-sightedness of the user.

In FIG. 1, only a single representative volumetric image is shown. More generally, a sequence of such volumetric images may be presented to form a moving image (i.e., a video). In such a case, the successive volumetric images are processed in the manner described below for one image. Furthermore, and as discussed further below, in certain embodiments, some processing may be performed prior to presentation and the intermediate processed forms of the volumetric images are stored for presentation, thereby reducing the amount of processing that is required at presentation time. Furthermore, in some cases in which the volumetric images are synthesized for example based on computer animation techniques, it may be possible to directly compute the intermediate processed forms without constructing an explicit volumetric form, for example, based on a surface representation of the objects to be displayed. Yet other alternatives are discussed later in this document.

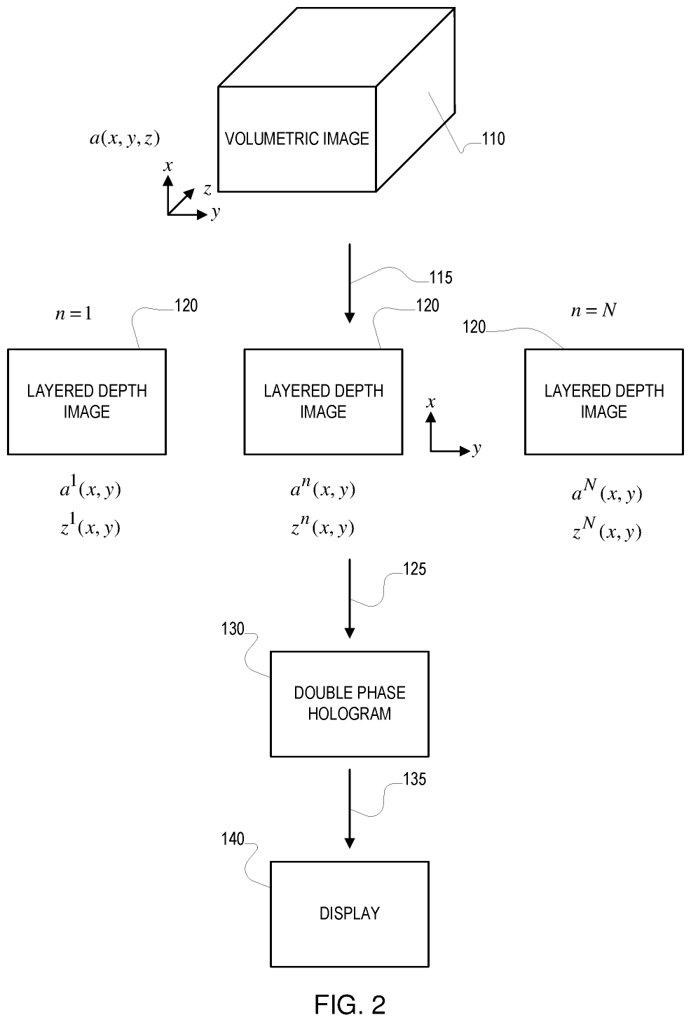

Referring to FIG. 2, processing in an example of the display system 100 introduced in FIG. 1 can be understood in terms of a succession of transformations. For the sake of simplicity of presentation, only a single color channel is considered, and the reader should recognize that wherever there is a reference to an intensity or amplitude of an image, more generally a tuple of such intensities and amplitudes for multiple color channels of the image are processed, with ultimately multiple color channels being presented to the viewer so that they perceive a color image. With this in mind, the volumetric image may be represented as an array a(x, y, [symbol] ), where a is the intensity (i.e., a scalar non-negative value) of the image at a three-dimensional point (x, y, [symbol] ) , with the convention that a=0 if there is no object surface at that location. In this coordinate system, the x-y plane is parallel to the holographic plane for which the hologram 130 will be generated, and the [symbol] direction grows algebraically in the direction moving away from the viewer, with the value of the [symbol] coordinate being referred to as the “depth” in the volumetric image (e.g., [symbol] =0 on the holographic plane).

A first transformation 115 produces a relatively small number (e.g., N=6) of layered depth images (LDI) 120. The n^{th} LDI includes for each pixel location (x, y) an intensity aⁿ(x, y) at that location, and a depth of the image [symbol] ⁿ(x, y) at that location (with the depth in general being shared among multiple color channels). Generally, the original volumetric image 110 may be approximated by combining the LDI images, such that

$$a ( x , y , z ) \approx \sum {a}^{n} ( x , y ) \\ n , where z \approx {z}^{n} ( x , y )$$

Note that while the x-y plane may be quantized into pixels, the depth values [symbol] (x, y) are not required to be similarly quantized, and therefore the depth resolution may be greater than might be attainable in an explicit three-dimensional voxel representation of the volumetric image (and accordingly in the equation above, [symbol] ≈ [symbol] ⁿ(x, y) represents a rounding to the depth of a voxel from a possibly higher accuracy depth of the LDI image). Such a higher resolution may be attainable, for example, by direct computation of the LDI during animation rather than explicitly producing an intermediate voxel representation. A variety of techniques may be used to compute the LDI images. For example, computation of LDI images for use in other image presentation tasks is described in Shade et al. “Layered depth images.” In Proceedings of the 25th annual conference on Computer graphics and interactive techniques, pp. 231-242. 1998, and in L. Bavoil, K. Myers, “Order independent transparency with dual depth peeling.” NVIDIA OpenGL SDK (2008). In this holographic application of LDI, sufficient parts of the volumetric image are represented in the LDI such that light paths through the aperture of display are sufficiently represented (i.e., all or at least sufficient rays though an imaging lens should be represented in the LDI images to avoid artifacts in the rendered hologram).

A learned transformation 125, which is discussed in detail below, is applied to the LDI images 125 to yield a double-phase hologram 130. This hologram provides a spatially-varying phase transformation for transmitted light through the display 140 but does not introduce a spatial amplitude variation. For example, local amplitude variation is achieved by summation of offsetting (e.g., equal magnitude) phase delays, for example, as represented in a complex representation with neighboring phase delays a and b (in radians), the net effect is e^{ja}+e^{jb}=cos(a−b)/2)e^{j(a+b)/2}.

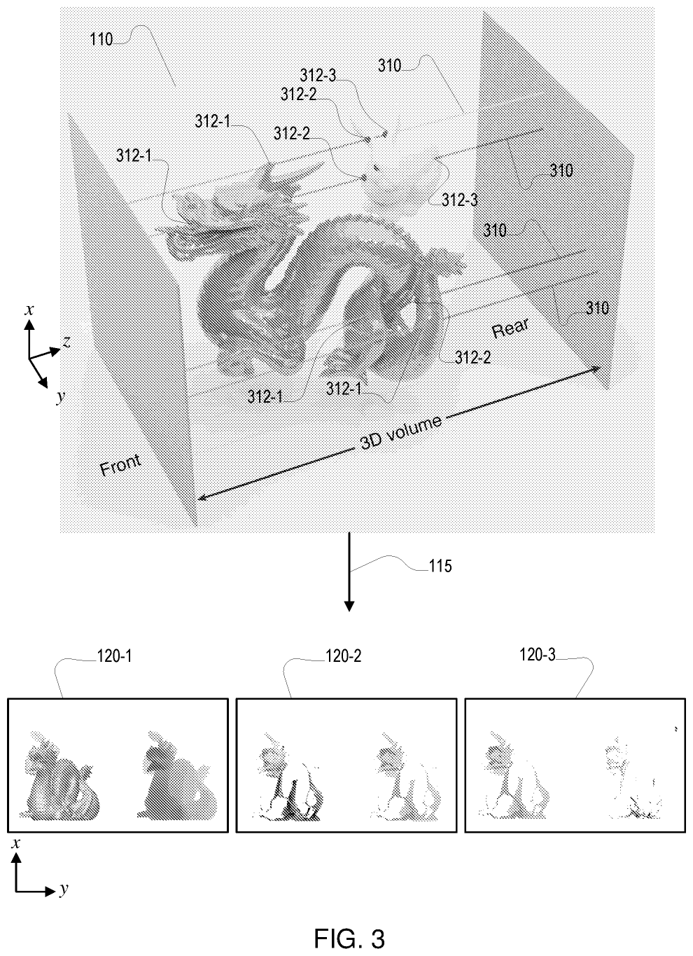

Referring to FIG. 3, an example of a volumetric image 110 is based on models of two figures, in this example, a dragon and a rabbit. A ray casting approach is used in which for each (x, y) pixel location, a ray 310 is cast through the volume in the [symbol] direction, and the intersections of each ray and the surfaces of the models of the objects in the volume are recorded. In FIG. 3, four representative rays 310 are shown, recognizing that a dense grid of such rays for all pixels would be used in practice. The first surface intersection points 312-1 are assigned to a first LDI 120-1. Each of three LDI 120-1 through 120-3 are illustrated with the intensity a(x, y) represented on the left and the depth [symbol] (x, y) represented in grey scale (lighter shade corresponding to larger [symbol] value) on the right. Similarly, the second intersection points 312-2 are assigned to LDI 120-2, and the third intersections are assigned to LDI 120-3. The reader should note that each successive LDI optionally does not necessarily include all intersecting points as those surface intersections that are occluded to such a degree that they are not needed to contribute to the ultimate display may be omitted. The reader should also note that the intensity of the first LDI 120-1 is essentially a two-dimensional view of the objects because points in the higher-depth LDI are necessarily occluded when viewing directly down the [symbol] axis in such a two-dimensional view.

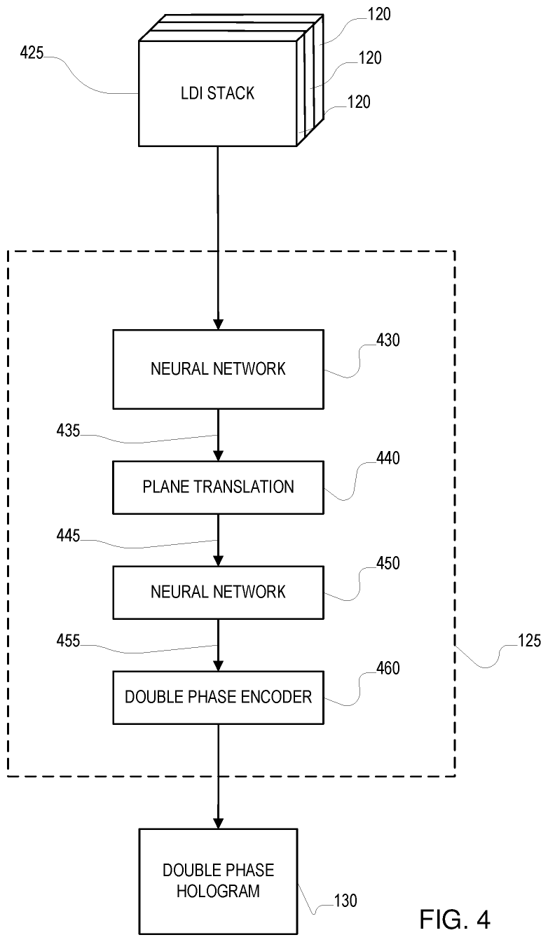

Referring to FIG. 4, the transformation from the set of LDI 120, represented as an LDI stack 425 in FIG. 4 of the individual LDI, is input to a learned multiple-step transformation that ultimately yields the double-phase hologram 130, which is then used for display. The transformation begins with a neural network 430, which processes the LDI stack. For example, if each LDI is an RGB+D image (i.e., four channels), and there are six LDI 120 in the stack, then then neural network 430 accepts a 24 channel input (i.e., each pixel location has a vector of 24 values). In general, the neural network 430 is a convolutional neural network with multiple layers. The output 435 of the neural network 430 a complex image with two output channels, for example, with one channel representing a magnitude and one channel representing a phase, or alternatively, with one channel representing a real part and one channel representing a complex part of a complex representation of amplitude and phase. In some embodiments, this complex image generally correspond to a complex “mid-plane” hologram on an x-y plane at a mid-value (e.g., the middle value) of the range of [symbol] values in the original volumetric image 110. This hologram is not used directly for display.

The output 435 of the first neural network 430 is then processed by a plane translation procedure 440. This plane translation is deterministic and represents a transformation that would be applied to a complex hologram at the mid-plane to yield a complex hologram at the desired display plane for use with the display 140. This transformation is defined by the free-space propagation from the mid plane to the display plane. This results in a complex hologram 445.

A second learned neural network 450 is applied to the complex hologram 445 to yield a modified hologram 455. This hologram is passed to a fixed (i.e., not learned and/or parameterized) double-phase encoder 460, which uses the amplitude and phase of each pixel value of the input hologram 455 to yield a phase-only representation, for example, at the same pixel resolution as the hologram or optionally at a greater resolution such as twice the pixel density of the hologram (i.e., two phase values per complex hologram value). Each phase value in the double-phase hologram controls one phase-delay element of the display 140.

Therefore, in summary, there are two learned (trained) transformations, the first neural network 430 and the second neural network 450, while the remaining transformation steps of plane translation 440 and double-phase encoding are fixed, for example, based on physical principles.

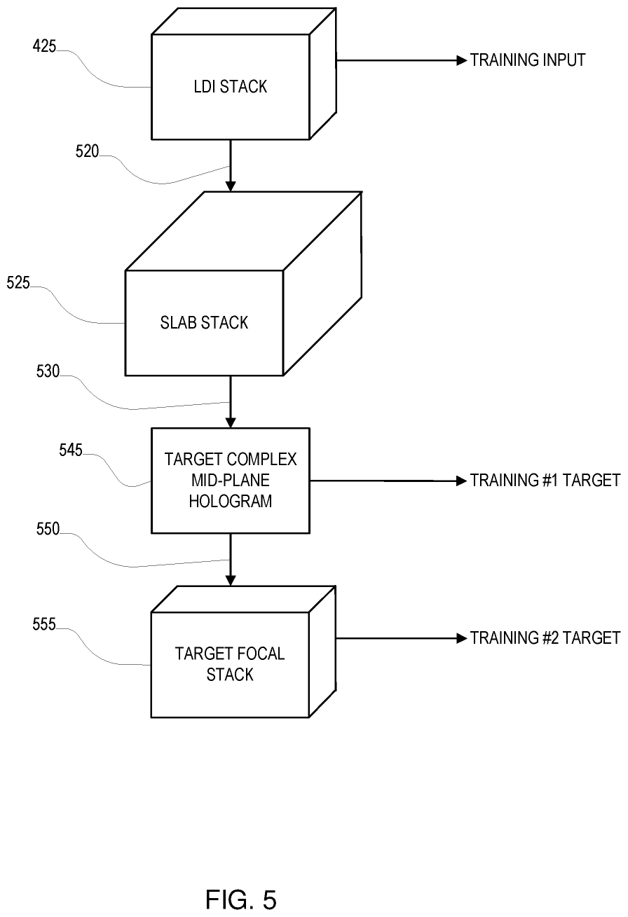

Referring to FIG. 5, in order to train the neural networks 430, 450, a training procedure makes use of training data, where each item of the training data has an LDI stack 425, which in general has been determined from a volumetric image, and corresponding to that LDI stack a complex mid-plane hologram 545, which represents a hologram computed from the LDI 120 of the LDI stack 425, as well as a set of images that collectively are referred to as a “focal stack” 555, which are computed from the mid-plane hologram 545.

Each image in the focal stack 555 is an image (e.g., an RGB image) rendered based on the hologram 545 with a different focus depth. Therefore, different parts of the original volumetric image will be in focus in each of the images of the focal stack. For example, the [symbol] dimension is uniformly sampled in to yield corresponding focal images of the focal stack at those sampled depth. These images are computed digitally based on the complex hologram using conventional imaging techniques. In some examples, the depths at which the focal stack images are focused is a fixed set, while in some examples, the depths depend on the content of the volumetric image, while in yet other examples, some of the depths are fixed and some are determined from the image.

Continuing to refer to FIG. 5, one approach to computing the target midplane hologram 545 is to first represent the LDI stack 425 by mapping points in each LDI 120 to a different plane (slab) in a dense uniformly spaced slab representation 525 by rounding the depth value of the LDI to depth location of the nearest slab. Having formed the slab representation 525, a technique such as described in Zhang, Hao, et al., “Computer-generated hologram with occlusion effect using layer-based processing.” Applied optics 56, no. 13 (2017): F138-F143. May be used. Note that this approach to computation of the hologram is not practical for computing the holograms in rendering new images, such offline computation of the holograms 545 is useful for creating a training set, and furthermore is not particularly tailored to forming a high quality phase-only hologram.

Note that the slab stack 525 may optionally be computed “on the fly” such that the required slabs of the stack may be computed during the forming of the target hologram. Such computation may be preferable to avoid having to store the entire slab stack before computing the hologram.

This target hologram 550 is then processed to digitally compute the images of the target focal stack. For example, angular spectral method (ASM) may be used as described in Matsushima, K. et al. “Band-limited angular spectrum method for numerical simulation of free-space propagation in far and near fields.” Opt. Express 17, 22, 19662-19673 (2009).

Training of the neural networks 430, 450 is performed in two stages. Dividing the training into these two stages may provide advantages of convergence to a better overall solution and/or more rapid convergence to a solution, thereby reducing the amount of computation required.

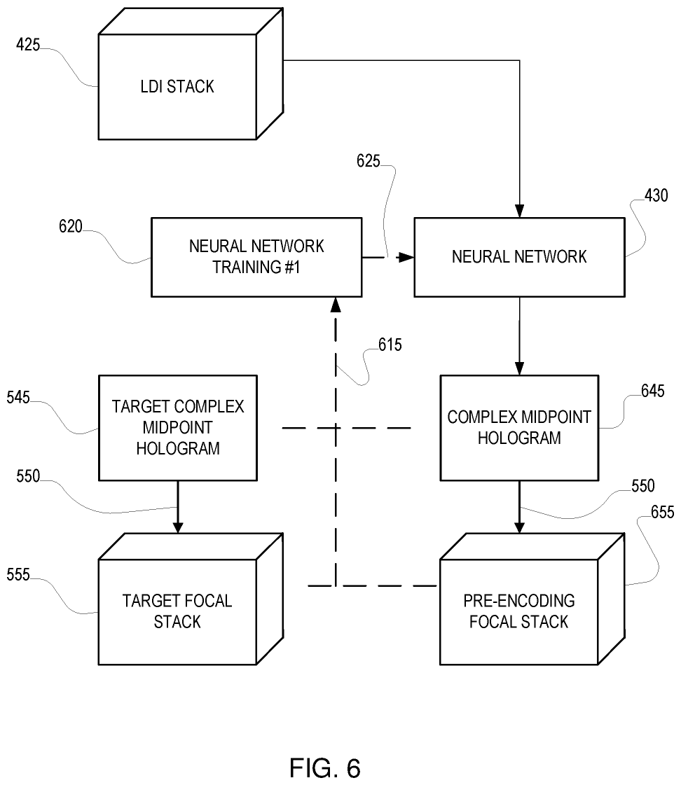

Referring to FIG. 6, a first training stage uses a neural network training module (“#1”) 620 to set values of learnable parameters (also referred to as “weights”) of the first neural network 430. In some examples, a gradient-based parameter update procedure is used to optimize a loss function. The loss function includes one term based on a difference between the target midpoint hologram 545 (generated as shown in FIG. 5) and the hologram 645 output from the neural network 430 in a manner dependent on the learnable parameters of the network 430. For example, a sum over pixel locations of squared differences may be used for this term. The loss function also includes terms that are based on the difference between focal stack images of the target focal stack 555 and corresponding focal stack images of a “pre-encoding” focal state 655 (i.e., at the same focus depths) determined from the midpoint holograms by a procedure 550, which is the same for both of the focal stacks. In some examples, squared differences between the focal images are used, optionally weighting regions of high variation (e.g., regions that may be “in focus”) in the focal images. The gradient of the loss function 615 is used by the training module 620 to update the weights of the neural network 430.

Note that a midpoint hologram computed by the trained first neural network 430 could be used for display, for example, by applying the plane transformation 440 (see FIG. 4) and the double phase encoder 460 to compute a hologram 130 for use in the display. However, improved quality is obtained by using a second training stage.

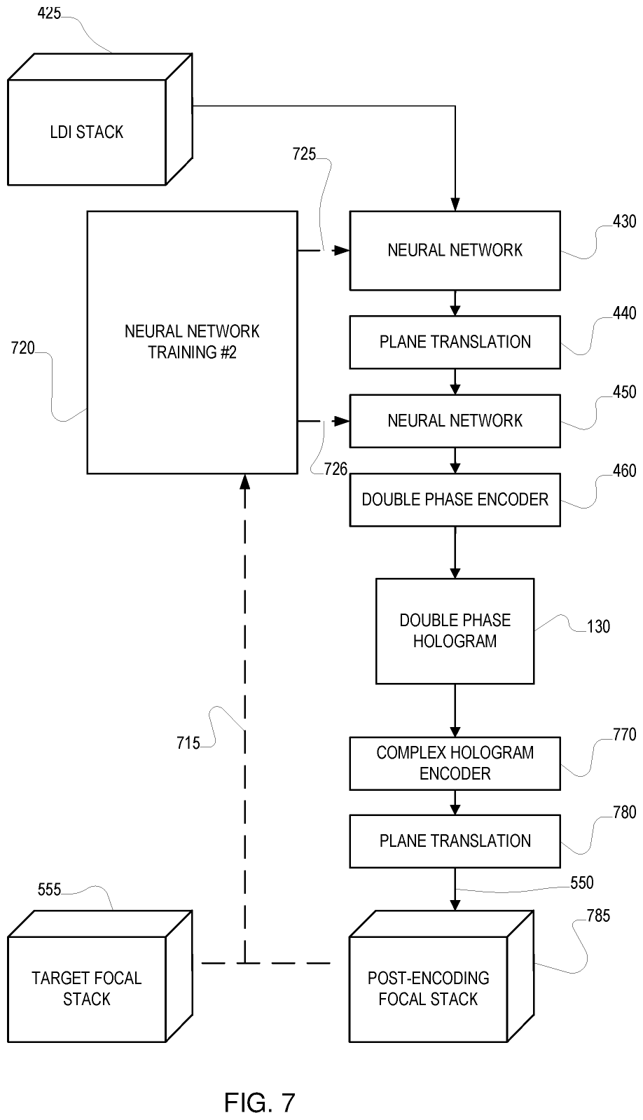

Referring to FIG. 7, a second training stage initializes the parameters for the first neural network 430 that are obtained in the first training stage described above. Therefore, without further training of the parameters of the neural network 430, the output of the first neural network is expected to be a reasonable representation/approximation of a complex midpoint hologram corresponding to the LDI stack 425. In some examples, the parameters of the neural network remain fixed, in other examples, these parameters are fixed during an initial training of other parameters in the second training stage, and in yet other examples, the parameters of the neural network 430 are initialized from the result of the first training stage and immediately incrementally updated during iterations of the second training stage.

The second training stage provides values of the trainable parameters 726 of a second neural network 450. As illustrated in FIG. 7 as well as in FIG. 4, the complex output of the neural network undergoes a deterministic transformation in the plane transformation module 440 that would transform a hologram at the mid plane to a display plane hologram 445, again represented in a complex (i.e., amplitude and phase) form. The output of the plane transformation 440 is provided as the input to the second neural network 450, which again produced a complex hologram 455. This complex hologram 455 passes through the fixed double-phase encoder 460 to yield the double phase hologram 130, which corresponds to the complex hologram 455.

Note that the double phase encoder embodies the capabilities of the display 140 via which the hologram will be displayed. For example, if phase settings have limited resolution or pixel resolution is limited, or there is a particular approach to assigning phase pairs to encode pixel amplitude and phase is phase-only pixels, such limitations are represented in the double-phase encoder 460 used in the training. Therefore, the neural network 450 has the possibility of compensating for limitations of the display or the phase-only encoding process.

The training approach does not have a direct reference to assess the quality of the double-phase hologram. Therefore, there is no direct way of defining a loss function according to which to train the neural network 460. Rather, the loss function is defined in terms of transformations of the double-phase hologram.

The transformations of the double-phase hologram that are used to evaluate the loss function beings with processing the phase-only hologram using a complex hologram encoder 770 to return the hologram back into a complex hologram form. This transformation is deterministic and makes use of the prediction of how light would be controlled by the pixels of the display. The complex hologram undergoes a plane transformation 780 to yield a mid-plane complex hologram 550. Generally, this mid-point hologram 550 corresponds to the mid-plane hologram 645 of the first training stage (see FIG. 6). However, unlike the mid-plane hologram of the first training stage, the mid-plane hologram 550 of the second training stage takes into account the characteristics of the phase-only encoding that will be used in the runtime system (see FIG. 4).

The mid-plane hologram 550 of the second training stage is transformed into a focal stack 785 (referred to as the “post encoding” focal stack) in a process that is essentially the same as that used to convert mid-plane hologram 645 to yield the focal stack 655 (referred to as the “pre-encoding” focal stack) as illustrated in FIG. 6. The loss function applied by the neural network training (“#2”) 720 compares the target focal stack 555 and the post-encoding focal stack 785, for example, based on a weighted squared difference between pixels of the respective focal stack images. As introduced above, the network training 720 updates the trainable parameters of the second neural network 460, and in at least some examples, may also update the parameters of the first neural network 430 in a joint training approach.

In examples in which the training takes into account non-ideal viewing optics through which the output hologram 130 is viewed, these non-ideal characteristics are “inverted” or otherwise compensated for in the output double-phase hologram 130. This is accomplished by the transformation of the mid-plane hologram 550 to the focal stack simulating the non-ideal optics characteristics. For example, if the hologram is to be presented to a human viewer 150 with near sight, the focal stack represents essentially the retinal images the viewer would sense rather than what an ideal camera would acquire with different focal lengths and aperture settings.

Having outlined the overall runtime and training approaches, the remainder of this document provides details of specific steps in which these approaches have been evaluated.

To compute a 3D hologram from an LDI, ray casting is performed from each point's mesh (i.e., pixel) at the recorded 3D location. Because runtime is ultimately unimportant for dataset synthesis, we use the silhouette-mask layer-based method (SM-LBM), as described in Zhang, H., Cao, L. & Jin, G. “Computer-generated hologram with occlusion effect using layer-based processing.” Appl. Opt. 56, F138-F143 (2017), with ultra-dense depth partition to avoid the mixed-use of geometric and wave optics models. SM-LBM was originally proposed to receive a voxel grid input generated by slab-based rendering, which does not scale with increasing depth resolution. Using SM-LBM with LDI is implemented such that a non-zero pixel in an LDI defines a valid 3D point before depth quantization. When the number of depth layers N is determined, each point is projected to its nearest plane, and a silhouette is set at the same spatial location. Denote the complex amplitude distribution of the N-th layer L_{N}∈ [symbol] ^{R}^{ₓ}^{×R}^{_{y}} as

$${L}_{N} = {A}_{N} exp ( i \frac{2 π {z}_{N}}{λ} ) .$$

Here, [symbol] _{N} is the signed distance from the N-th layer to the hologram plane, where a negative distance denotes a layer behind the hologram plane and vice versa, A_{N}∈ [symbol] ^{x}^{×R}^{_{y}} is the amplitude of the layer, Rₓ, and R_{y} are the spatial resolution along the x and y axis. The exponential term defines the layer's initial phase to induce a smooth and roughly zero-mean phase profile at the hologram plane (see Maimone, A., Georgiou, A. & Kollin, J. S. “Holographic near-eye displays for virtual and augmented reality,” i ACM Trans. Graph. 36, 1-16 (2017)). We use the angular spectrum method to propagate L_{N} to the location of N−1-th layer

$${C}_{N - 1} = ASM ( {L}_{N} , {d}_{l} ) = {- 1}^{} ( ( {L}_{N} ) ⊙ exp ( i 2 π {d}_{l} \sqrt{{λ}^{- 2} - {μ}^{2} - {v}^{2}} ) ) ,$$

where μ∈ [symbol] ^{R}^{ₓ}^{×R}^{_{y}} and υ∈ [symbol] ^{R}^{ₓ}^{×R}^{_{y}} are the spatial frequencies along the x and y directions, dₗ is the layer thickness (positive), ⊙ denotes Hadamard element-wise product, [symbol] and [symbol] ⁻¹ are the 2D Fourier transform and inverse Fourier transform operator. C_{N-1} is multiplied by the binary silhouette mask at the N−1 layer

$${M}_{N - 1} ( x , y ) = \{ \begin{matrix}0 , {A}_{N - 1} ( x , y ) > 0 \\ 1 , {A}_{N - 1} ( x , y ) = 0\end{matrix}$$

and the complex amplitude at the N−1 layer is updated by adding the masked complex field

L_{N-1}=C_{N-1}M_{N-1}+L_{N-1}.

By iterating this process until reaching the first layer, the final complex hologram is obtained by propagating the updated first layer to the hologram plane.

We further augment SM-LBM with aberration correction at a cost of computational efficiency. Reconsidering the forward propagation of N-th layer L_{N}, we only process the occlusion of frontal layer without adding their content, namely removing the second addition term in the previous equation. After processing occlusion of all frontal layers, we propagate the resulted wavefront back to the starting location of Ly to obtain an occlusion-processed L′_{N}. We then perform aberration correction in the frequency domain

L′_{N}_{_{C}}= [symbol] ⁻¹( [symbol] (L′_{N})⊙Φ [symbol] _{_{N}}),

where [symbol] ∈ [symbol] ^{R}^{ₓ}^{×R}^{_{y}} is a depth-dependent global aberration correction kernel in the Fourier domain. Finally, L′_{N}_{_{C}} is propagated to the target hologram plane. This procedure is repeated independently for the content at every discretized depth (i.e., from layer 1 to N) and integrating the results of all procedures at the target plane forms the final hologram. Note that the required total number of propagation operations increase to N²/2 compared with N in the standard SM-LBM.

SM-LBM and its aberration-correction variant may be slow due to sequential occlusion processing. To improve the performance, we generate a new dataset with LDIs and SM-LBM holograms, and train a CNN to accelerate inference. Generating this dataset involves setting three significant parameters: the depth of the 3D volume, the number of layers used by LDIs, and the number of layers (depth resolution) used by SM-LBM.

We set the 3D volume depth to be 6 mm under collimated illumination to facilitate quantitative comparison with the publicly available TensorHolo VI1 network as described in Shi, L., et al. “Towards real-time photorealistic 3D holography with deep neural networks,” Nature 591, 234-239 (2021), and similarly for the random scene configuration. To determine the number of layers for LDIs, we compute the mean peak signal to noise ratio (PSNR) and the mean structure similarity index (SSIM) for the amplitude maps of the holograms computed from LDIs with N=1,2, . . . ,9 layers against the ones computed from LDIs with N=10 layers (after which we observe few valid pixels) over 10 random scenes. The mean SSIM plateaus after N=5, reflecting a diminishing improvement with more layers. Thus, we choose N=5 for this work, but more layers can be used for higher accuracy. Similarly, to determine the number of layers for SM-LBM, we compute the holograms using 2^{N}^{_{d}} layers for N_{d}=5,7,9,11 and compare the mean PSNR and the mean SSIM of these holograms against the ones computed from N_{d}=13 over 10 random scenes. The mean SSIM plateaus after N_{d}=11, indicating negligible improvement for the 3D image quality. Nevertheless, we use a partition of 10000 layers (13.28-bit depth) as a showcase, which has not been demonstrated previously. We rendered MIT-CGH-4K-V2, a new hologram dataset with 4000 pairs of LDIs and holograms with 3800 for training, 100 for validation, and 100 for testing at 384×384 pixels similar to TensorHolo V1.

Although a CNN can be trained to directly predict an unconstrained 3D phase-only hologram using unsupervised learning by only forcing the focal stack to match the one produced by the target complex hologram, ablation studies have shown that removing the supervision of ground truth complex hologram noticeably degrades the image quality and enforcing the phase-only constraint can only worsen the performance. Moreover, direct synthesis of phase-only holograms prevents the use of midpoint hologram for reducing computational cost since learning an unconstrained midpoint phase-only hologram does not guarantee a uniform amplitude at the target hologram plane.

As introduced above, a two-stage supervised and unsupervised training is used to overcome these challenges. An insight is to keep using the double phase principle to perform phase-only encoding for retaining the advantage of learning the midpoint hologram, while embedding the encoding process into the end-to-end training pipeline and relegating the CNNs to discover the optimal pre-encoding complex hologram through unsupervised training. We detail the training process below and refer to this neural phase-only conversion method as the deep double phase method (DDPM).

The first stage supervised training trains two versions of CNNs. Both are trained to predict the target midpoint hologram computed from the LDI input, but one receives the full LDI and the other receives only the first layer of the LDI. The latter CNN has an additional job to hallucinate the occluded points close to the depth boundaries and fill in their missing wavefront. It is particularly useful for reducing the rendering overhead and for reproducing real-world scenes captured as RGB-D images, where physically capturing a pixel-aligned LDI is nearly impossible.

Once the CNN excels at this task, we initialize the second stage unsupervised training by applying a chain of operations to the network-predicted midpoint hologram \tilde{H}_{mid}=Ã_{mid}exp(i\tilde{ϕ}_{mid}). First, it is propagated to the target hologram plane and pre-processed by a second CNN to yield the pre-encoding target hologram prediction

$${\tilde{H}}_{tgt - pre} = {\tilde{a}}_{tgt - pre} {\tilde{A}}_{tgt - pre} exp ( i {\tilde{ϕ}}_{tgt - pre} ) = CNN ( ASM ( {\tilde{H}}_{mid} , {d}_{offset} ) exp ( i \frac{2 π {d}_{offset}}{λ} ) )$$

where d_{offset} is the signed distance from the midpoint hologram to the target hologram plane, Ã_{tgt-pre} is the normalized amplitude, and ã_{tgt-pre} is the scale multiplier. The second CNN serves as a content-adaptive filter to replace the Gaussian blur in AA-DPM. The exponential phase correction term ensures that the phase after propagation is still roughly centered at 0 for all color channels. It is also important to the success of AA-DPM, which minimizes phase wrapping. Next, the standard double phase encoding is applied to obtain a phase-only hologram

P(x, y)=0.5ã_{tgt-pre}exp(i(\tilde{ϕ}_{tgt-pre}(x, y)−cos⁻¹Ã_{tgt-pre}(x, y))), when x+y is odd, and

P(x, y)=0.5ã_{tgt-pre}exp(i(\tilde{ϕ}_{tgt-pre}(x, y)+cos⁻¹Ã_{tgt-pre}(x, y))), when x+y is even.

and no pre-blurring is applied in contrast to AA-DPM. Third, the phase-only hologram is filtered in the Fourier space to obtain the post-encoding target hologram prediction

\tilde{H}_{tgt-post} = [symbol] ⁻¹( [symbol] (P)⊙M_{Fourier}),

where M_{Fourier} models a circular aperture in the Fourier plane

$${M}_{Fourier} = \{ \begin{matrix}1 , {x}^{2} + {y}^{2} \leq {r}^{2} \\ 0 , {x}^{2} + {y}^{2} < r\end{matrix}$$

Here, r is the radius of the aperture in the pixel space. We set it to half of the image resolution, which lets the entire first-order diffraction pass through the physical aperture. Finally, the post-encoding target hologram prediction is propagated back to yield the post-encoding midpoint hologram

\tilde{H}_{mid-post}=ASM(\tilde{H}_{tgt-post},d_{offset}).

By appending these operations, the second stage unsupervised training fine-tunes the CNN prediction using the dynamic focal stack loss calculated between the post-encoding midpoint hologram and the ground truth midpoint hologram, plus a regularization loss on the pre-encoding target hologram phase

$${l}_{tgt - pre} = \sqrt{\frac{\sum {( {\tilde{ϕ}}_{tgt - pre} - mean ( {\tilde{ϕ}}_{tgt - pre} ) )}^{2}}{{R}_{x} {R}_{y}}} + mean ( {\tilde{ϕ}}_{tgt - pre} ) ,$$

The regularization loss encourages the pre-encoding target hologram phase to be zero mean and to exhibit a small standard deviation. This term minimizes phase wrapping during the double phase encoding, which may not affect the simulated image quality but may degrade the experimental result. Without this loss, the unregulated phase exhibits a large standard deviation and shifts away from zero mean, leading to non-negligible phase wrapping, especially when the maximum phase modulation is limited to 2π.

In the second training stage, direct supervision from the ground truth midpoint hologram is intentionally ablated. This expands the solution space by allowing the CNNs to freely explore the neural filtering to optimally match the ground truth focal stack, which a user ultimately sees. It also facilitates regularization on the pre-encoding target hologram phase to better handle hardware limitations (i.e., limited range of phase modulation). In practice, the resulting prediction of the post-midpoint hologram phase visually differs from the ground truth as high-frequency details are attenuated or altered in a spatially-varying and content-adaptive manner to avoid speckle noise. With direct supervision that encourages retention of high-frequency details, we find it negatively impacts speckle elimination.

Collectively, the two-stage training first excels at reproducing the ground truth complex 3D holograms at all levels of detail, then fine-tunes a display-specific CNN for fully automatic speckle-free 3D phase-only hologram synthesis. The second training stage takes fewer iterations to converge, therefore, upon the completion of the first training stage, it is efficient to optimize multiple CNNs for different display configurations. The training process is detailed below.

The CNNs are implemented and trained using TensorFlow 1.15 on an NVIDIA RTX 8000 GPU with Adam optimizer. The hologram synthesis CNN consists of 30 convolution layers with 24 3×3 kernels per layer. The pre-filtering CNN uses the same architecture, but with only 8 convolution layers and 8 3×3 kernels per layer. When the target hologram coincides with the midpoint hologram, the pre-filtering CNN can be omitted. The learning rate is 0.0001 with an exponential decay rate of β₁=0.9 for the first moment and β₁=0.99 for the second moment. The first stage training runs for 3000 epochs. The second stage training first pre-trains the pre-filtering CNN 50 epochs for identity mapping and then 1000 epochs jointly with the hologram synthesis CNN. The pre-training accelerates the convergence and yields better results. Both versions of CNN use a batch size of 2, w_{data}=1.0, w_{pcp}=1.0, w_{tgt-pcp}=0.07, where w_{data}, w_{pcp}, w_{tgt-pcp} are the weights for the data fidelity loss, the dynamic focal stack loss, and the regularization loss.

The experimental setup uses a HOLOEYE PLUTO (VIS-014) phase-only LCOS with a resolution of 1920×1080 pixels and a pixel pitch of 8 μm. This SLM provides a refresh rate of 60 Hz (monochrome) with a bit depth of 8 bits. The laser is a FISBA RGBeam single-mode fiber-coupled module with three optically aligned laser diodes at wavelengths of 638, 520, and 450 nm. The diverging beam emitted by the laser is collimated by a 300 mm achromatic doublet (Thorlabs AC254-300-A-ML) and polarized (Thorlabs LPVISE100-A) to match the SLM's function polarization direction. The beam is directed to the SLM by a beamsplitter (Thorlabs BSW10R), and the SLM is mounted on a linear translation stage (Thorlabs XRN25P/M). When displaying holograms with different relative positions to the 3D volumes, we adjust the linear translation stage to keep the position of 3D volumes stationary and thus avoid modification of the following imaging optics. The modulated wavefront is imaged by a 125 mm achromat (Thorlabs AC254-125-A-ML) and magnified by a Meade Series 5000 21 mm MWA eyepiece. An aperture is placed at the Fourier plane to block excessive light diffracted by the grating structure and higher-order diffractions. A SONY A7M3 mirrorless full-frame camera paired with a 16-35 mm f/2.8 GM lens is used to photograph the results. A Labjack U3 USB DAQ is used to send field sequential signals and synchronize the display of color-matched phase-only holograms.

Hardware imperfection can cause experimental results to deviate from the idealized simulations. Here we discuss methods to compensate three sources of error: laser source intensity variation as a Gaussian beam, SLM's non-linear voltage-to-phase response, and optical aberrations.

To calibrate the laser source intensity variation, we substitute the SLM with a diffuser and capture the reflected beam as a scaling map for adjusting the target amplitude. A 5×5 median filter is applied to the measurements to avoid pepper noise caused by dust on the optical elements. A Gaussian mixture model can be used to fit an analytical model of the resulting scaling map if needed.

For an imprecisely calibrated SLM, the non-linear voltage-to-phase response can severely reduce display contrast, especially for double-phase encoded hologram since achieving deep black requires offsetting the checkerboard grating accurately by 1π. In many cases, the pixel response is also spatially non-uniform, thus using a global look-up table is often inadequate. Other calibration methods may operate on the change of interference fringe offset or the change of near/far-field diffraction pattern, but they do not produce a per-pixel look-up table (LUT). The present calibration procedure that uses double phase encoding to accomplish this goal. Specifically, for every 2-by-2 pixels, we keep the top right and bottom left pixels at 0 as a reference and increase the top left and bottom right pixels jointly from 0 to 255. Without modifying the display layout, we set the camera focus on the SLM and capture the change of intensity for the entire frame. If the phase modulation range for the operating wavelength is greater equal than 2π, the intensity of the captured image will decrease to the minimum at 1 kπ offset, return to the maximum at 2π offset, and repeat this pattern for every 2π cycle. Denote the k -th captured image Iₖ, the absolute angular difference in the polar coordinate between a reference pixel and an active pixel set to k is

$${θ}_{k} ( x , y ) = 2 {cos}^{- 1} ( \frac{\sqrt{{I}_{k}} ( x , y ) - \sqrt{{I}_{min}} ( x , y )}{\sqrt{{I}_{max}} ( x , y ) - \sqrt{{I}_{min}} ( x , y )} ) ,$$

where Iₘᵢₙ(x, y) and Iₘₐₓ(x, y) are the minimal and maximal intensities measured at location (x, y) when sweeping from 0 to 255. Let kₘᵢₙ(x, y) be the frame id associated with the minimal measurement at (x, y), the phase difference is given by

$${ϕ}_{k} ( x , y ) = \{ \begin{matrix}{θ}_{k} ( x , y ) & k \leq {k}_{min} ( x , y ) \\ 2 π - {θ}_{k} ( x , y ) & k > {k}_{min} ( x , y )\end{matrix}$$

Experimentally, we take high-resolution measurements (24 megapixels) of the SLM response, downsample to the SLM resolution, perform the aforementioned calculations, and fit a linear generalized additive model (GAM) with monotonic increasing constraint to obtain a smoothed phase curve for producing a per-pixel LUT. For simplicity, the LUT is directly loaded into the GPU memory for fast inference. To reduce memory consumption, a multi-layer perceptron can be learned and applied as a 1×1 convolution. This in-situ calibration procedure eliminates potential model mismatch between a separate calibration setup and the display setup. The ability to accurately address phase difference results in more accurate color reproduction, i.e., producing deep black by accurately addressing 1π phase offset.

The optical aberrations are corrected using a variant of a technique described in Maimone, A., Georgiou, A. & Kollin, J. S. “Holographic near-eye displays for virtual and augmented reality,” ACM Trans. Graph. 36, 1-16 (2017). Let ϕ_{d}∈ [symbol] ^{R}^{ₓ}^{×R}^{_{y}} (zero-padded to the frame resolution) an ideal sub-hologram that focus plane wave to a signed distance, d, may use 5 Zernike polynomials:

| | |
|---|---|
| Z₃ (ρ, θ) = a₃_{_{d}} (2ρ² − 1) | focus |
| Z₄ (ρ, θ) = a₄_{_{d}} (ρ² cos 2θ) | vertical astigmatism |
| Z₅ (ρ, θ) = a₅_{_{d}} (ρ² sin 2θ) | oblique astigmatism |
| Z₆ (ρ, θ) = a₆_{_{d}} ((3ρ² − 2)ρcosθ) | horizontal coma |
| Z₇ (ρ, θ) = a₇_{_{d}} ((3ρ² − 2)ρsinθ) | vertical coma |

to model system aberrations, where aⱼ_{_{d}} are Zernike coefficients, ρ is the normalized polar radius, and θ is the azimuthal angle. We perform a user calibration to adjust coefficients aⱼ_{_{d}} until the camera images a tightly focused spot at d from the corrected sub-hologram ϕ_{d}. Once the calibration completes, we propagate ϕ_{d} to its focal plane to obtain the point spread function and compute the corrected amplitude transfer function as
Φ_{d}=ATF_{d}= [symbol] (PSF_{d})= [symbol] (ASM(ϕ_{d},d)), which we use to perform frequency-domain aberration correction for the occlusion-processed layer. Note that this calibration procedure can be performed for different focal distances, and parameters can be piecewise linearly interpolated.

For compact setups with strong aberrations, spatially-varying aberration correction is often needed. In this case, we can calibrate the display at multiple points (i.e., 15 points) and update the above procedure by convolving a spatially varying PSF_{d} (x, y) calculated by interpolating the nearest measured parameters. Note that this operation can only be performed in the spatial domain but not in the Fourier domain. However, GPUs can accelerate this process, and speed is ultimately not critical for the sake of dataset generation. On the learning side, the CNN needs to receive an additional two-channel image that records the normalized x-y coordinates to learn aberration correction in a spatially-varying manner.

Examples of the approaches described above may be implemented in software, in hardware, or in a combination of software and hardware. Hardware may include application specific integrated circuits (ASICs), field programmable gate arrays (FPGAs) and the like. Software includes instructions, which are generally stored on non-transitory machine-readable media. Such instructions may be executed by a physical (i.e., circuit-implemented) processor, such as a general purpose computer processor (e.g., a central processing unit, CPU), a special purpose or application-specific processor, or an attached processor, such as a numerical accelerator, graphics processing unit (GPU). The processor may be hosted in a variety of devices. For example, for presentation of three-dimensional content to a user, the hologram generation procedures described above may be executed in whole or in part on a mobile user device, such as a smartphone, a head-mounted display system (e.g., 3D goggles), or as part of a heads-up display (e.g., an in-vehicle display). Some or all of the procedures may be performed at a central computer, for example at a network accessible server in a data center (which may be referred to as being in the “cloud”). Some of the computations may be performed while content is being displayed, while some of the computations may be performed in non-real time before presentation. For example, and LDI representation of an image may be performed before presentation of a three-dimensional video to the user. Training procedures can be performed on different computers than the runtime rendering of content to the user. Incorporating optics corrections into the neural networks may be done ahead of time, for example, prior to fielding a system to a particular user. In other examples, the neural networks are adapted to the characteristics of a particular user by modifying the parameters of the neural networks prior to using them for display to the user.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A method for generating a digital hologram comprising:
accepting a layered representation of a three-dimensional image, wherein the layered representation of the three-dimensional image comprises a plurality of image layers, and wherein each of the image layers comprises varying depth data across the image; and
forming the digital hologram from the layered representation.

2. The method of claim 1, wherein each image layer comprises an image comprising at least one color channel and a depth channel.

3. The method of claim 1, wherein the layered representation of the three-dimensional image comprises, for each location of the digital hologram, a plurality of depth values each representing spatial coordinates of a point along a line at an intersection of the line and a surface of an object in the three-dimensional image.

4. The method of claim 1, wherein the layered representation of the three-dimensional image further comprises for each location of the digital hologram a plurality of image values each representing intensity of one or more color channels at a point along the line at an intersection of the line and the surface of the object in the three-dimensional image.

5. The method of claim 1, further comprising determining the layered representation of the three-dimensional image.

6. The method of claim 5, further comprising determining a direction of view, and wherein determining the layered representation depends on said direction of view.

7. The method of claim 1, wherein forming the digital hologram comprises iterating through a sequence of present planes with successive depths, each iteration including one or more operations of:
(i) for points in the layered representation for which a depth of the point maps to a depth of the present plane, generating a contribution to complex amplitude distribution based on an intensity of the point in the layered representation;
(ii) propagating a previously generated complex amplitude distribution to the present plane;
(iii) masking a contribution from a prior plane according to a mask based on points that map to the present plane, and (iv) combining contributions of points whose depths map to the depth of the present and masked propagation of contributions from prior layers.

8. The method of claim 1, wherein forming the digital hologram from the layered representation comprises processing said layered representation using at least one neural network to generate the digital hologram.

9. The method of claim 8, wherein the digital hologram comprises a double-phase representation of said hologram.

10. The method of claim 8, wherein processing the layered representation of a three-dimension image using the at least one neural network comprises applying a first convolutional neural network (CNN) to an input based on the layered representation.

11. The method of claim 10 wherein applying said first CNN comprises applying said first CNN to an input comprising at least one of the layered representation and a function of said layered representation, and producing an output comprising at least one of said digital hologram and data from which said digital hologram is computed.

12. The method of claim 11, further comprising producing a first complex hologram with the first CNN, and applying a second CNN to an input comprising at least one of the first complex hologram and a function of said first complex hologram, and producing an output of said second CNN comprising at least one of said digital hologram and data from which said digital hologram is computed.

13. The method of claim 12, wherein producing an output for the second CNN comprises producing a second complex hologram, and wherein processing the layered representation further comprises encoding the second complex hologram as a double-phase representation of the digital hologram.

14. A method for determining values of configurable parameters the one or more neural network for generating a digital hologram comprises using training data comprising a plurality of training items, each training item comprising at least one of a layered representation of a three-dimensional image and a function of said layered representation and a corresponding function of a double-phase encoding of a target hologram determined based on said layered representation, and determining said values of the configurable parameters to match predictions of said functions of the double-phase encodings determined using said one or more neural networks.

15. (canceled)

16. (canceled)

17. The method of claim 14, wherein determining the target hologram comprises determining said hologram to incorporate correction of a vision or lens characteristic.

18. The method of claim 14, wherein the function of a double-phase encoding comprises a focal stack of images.

19. The method of claim 18, comprising computing the focal stack to include a set of images determined at different focal lengths derived from the double-phase encoding.

20. The method of 14, wherein the one or more neural networks include a first CNN and a second CNN, and wherein the method comprises determining values of configurable parameters of the first CNN based on a matching of target holograms with outputs of said first CNN.

21. The method of claim 20, further comprising determining values of configurable parameters of the second CNN using inputs produced by the first CNN and based on matching a function of a double-phase encoding determined from an output for the second CNN with a corresponding function of the target hologram.

22. (canceled)

23. A digital processor configured to generating a digital hologram by:
accepting a layered representation of a three-dimensional image, wherein the layered representation of the three-dimensional image comprises a plurality of image layers, and wherein each of the image layers comprises varying depth data across the image; and
forming the digital hologram from the layered representation.

24. A non-transitory machine-readable medium comprising instructions stored thereon, execution of said instructions by a digital processor causing said processor to generating a digital hologram by:
accepting a layered representation of a three-dimensional image, wherein the layered representation of the three-dimensional image comprises a plurality of image layers, and wherein each of the image layers comprises varying depth data across the image; and
forming the digital hologram from the layered representation.
